(19) United States
(12) Patent Application Publication
(10) Pub. No.: US 2015/0018311 A1
(43) Pub. Date: Jan. 15, 2015

(54) THERAPEUTIC BORON-CONTAINING COMPOUNDS

(71) Applicant: University of Tromsø, Tromsø (NO)

(72) Inventors: Tore Lejon, Tromso (NO); John Sigurd Svendsen, Tromso (NO); Alexey Gorovoy, Tromso (NO); Olga Gozhina, Tromso (NO)

(73) Assignee: University of Tromsø, Tromsø (NO)

(21) Appl. No.: 14/371,236

(22) PCT Filed: Jan. 8, 2013
(86) PCT No.: PCT/GB2013/050020

§ 371 Date: Jul. 9, 2014

(30) Foreign Application Priority Data
Jan. 9, 2012 (GB) 1200338.0
Jun. 12, 2012 (GB) 1210364.4

(51) Int. Cl. C07F 5/04

(52) U.S. Cl. CPC C07F 5/04
USPC 514/64; 558/288; 548/405

(57) ABSTRACT

The present invention relates to compounds of Formula (I) wherein R₁ and R₃ are hydrogen; R₂ and R₄, which may be the same or different, are hydrogen, a C₁₋₆ alkyl group optionally substituted by an aryl group which may itself be substituted, the substituent group including an alkyl group or an —OR group in which R is a C₁₋₃ alkyl group, with one or more hydrogen atoms optionally replaced with a halogen atom; or an aryl group which may be substituted, the substituent group including an alkyl group or an —OR group in which R is a C₁₋₃ alkyl group, with one or more hydrogen atoms optionally replaced with a halogen atom; with the proviso that R₂ and R₄ are not both hydrogen; the atom of R₄ which is attached to C_{β} is either a saturated carbon atom or an atom which is part of a 1 substituted aromatic ring; (AA)₀₋₅ is an amino acid, amino acid derivative, peptide of up to 5 amino acids or a peptidomimetic thereof which optionally incorporates an N-terminal capping group, when the group is (AA)₀ an N-terminal capping group is present, covalently attached to the nitrogen atom shown in Formula (I) and the capping group comprises at least 5 non-hydrogen atoms; R₅ is hydrogen or a C₁₋₃ 20 alkyl group, when AA=0, R₅ may form a cyclic group with the N-terminal capping group; R₆ and R₇ independently of one another denote hydrogen or a C₁₋₆ alkyl group; or together with the boron atom and the oxygen atoms, form a mono-, bi- or tricyclic, saturated or partly unsaturated, mono-, di-, tri- or tetra-C₁₋₆ alkylated or phenylated ring sysem having 5-18 ring members; and salt forms and stereoisomers thereof. The invention further relates to pharmaceutical formulations containing these compounds and the use of these compounds in therapy, particularly as antimicrobial agents, more particularly as an agent effective in treating a Mycobacterium tuberculosis infection or a Candida albicans infection. (I)

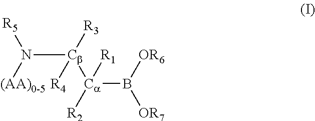

The present invention relates to novel compounds exhibiting antimicrobial activity and to the medical and other uses thereof. More specifically, these compounds are active against Mycobacterium tuberculosis.

Mycobacterium tuberculosis (MTB) is a pathogenic bacterial species and the causative agent of most cases of tuberculosis (TB). It is primarily a pathogen of the mammalian respiratory system and infects the lungs. In the lungs it is taken up by alveolar macrophages which fail to digest it and so the bacteria multiplies within the macrophage. One third of the world's population is infected with MTB and each year around 8 million people become sick from TB and 2 million people die.

It may take many months from the time the infection initially gets into the lungs until symptoms develop and for the majority of those affected, the bacteria lie dormant for years. Impairment of the patient's immune system is a typical trigger for development of the disease. The initial symptoms, include loss of appetite, fever, productive cough and loss of energy or weight. Primary pulmonary tuberculosis is the first stage of the condition and it may cause fever, dry cough and some abnormalities that may be noticed on a chest X-ray.

MTB infection may result in tuberculous pleuritis, a condition that may cause symptoms such as chest pain, nonproductive cough and fever. Moreover, infection with M. tuberculosis can spread to other parts of the body, especially in patients with a weakened immune system. This condition is referred to as miliary tuberculosis, and people contacting it may experience fever, weight loss, weakness and anorexia.

In cases in which the infection spreads to other parts of the body, additional and potentially very serious symptoms and complications may occur, depending on the exact site of the spread. For example, painful urination might be a sign the infection has reached the bladder. In children, MTB infections may affect the bones, causing mild swelling and pain. Fever, headache, nausea, drowsiness and, if untreated, coma and brain damage may occur if the brain has been affected. Kidney damage and sterility may occur if the kidney and the reproductive system respectively are affected.

So far as treatment of TB or MTB infections is concerned, antibiotics are usually part of the therapeutic regimen in people who have no symptoms, because they are helpful in preventing the activation of the infection. An antibiotic commonly used is isoniazid (INH), usually taken for six to 9 or 12 months, to prevent future activation. This medicine may not, however, be taken during pregnancy or in people who suffer from liver disease or alcoholism. Moreover, several side effects have been reported, some of which can be life-threatening.

Patients who have active bacteria are treated with a combination of medications known as first line drugs; these are isoniazid, rifampicin, ethambutol and pyrazinamide. The standard treatment course is two months of these four drugs and then isoniazid and rifampicin for a further four months. This multi-drug approach is required because of the degree of resistance shown by individual MTB to each drug, in other words, a proportion of bacteria in a patient will likely be resistant to each drug. Usually treatment lasts for several months but drugs may have to be administered for years in some cases.

Streptomycin, a drug given by injection, may be used, particularly when the disease is extensive and/or the patients do not take their oral medications. A variety of other second and third line drugs are known for the treatment of TB and are of particular importance in the treatment of multidrug resistant TB (MDR-TB) and extensively drug-resistant TB (XDR-TB), which are MTB infections showing resistance to standard first line drugs. The mortality rates are significantly worse with patients who have MDR-TB or XDR-TB as the treatment options are reduced and the regimens complex and expensive. Mismanagement of first line treatment of TB can result in the development of MDR-TB and XDR-TB. The four drugs used in first line treatment are decades old and this contributes to the prevalence of resistance. Thus there is an urgent need for drugs to treat MDR-TB and XDR-TB and to provide alternatives to the standard first line drugs.

The present inventors have surprisingly found that a series of novel aminoboronic acids and esters display good activity against Mycobacterium tuberculosis. As described by Rezanka et al. in Phytochemistry 69 (2008) 585-606, some naturally occurring boron containing compounds have been shown to have antimicrobial activity, in particular against Gram positive species, but these compounds are structurally dissimilar to those disclosed herein.

The activity exhibited by the compounds of the invention was identified in a serendipitous manner. Short antimicrobial peptides or peptidomimetics (SAMPs), as described, for example, in PCT/GB01/01035, are a promising class of antibiotics which act to lyse bacterial cell membranes. These SAMPs have been shown to be effective against various bacteria but not MTB. Resulting from work done to manipulate in vivo stability of SAMPs, a new group of molecules was identified with a surprising toxic effect against MTB and generally poor activity against other bacteria. Although not wishing to be bound by theory, a non-lytic mode of action is proposed for the molecules of the present invention.

Thus in a first aspect, the present invention provides a compound of formula (I)

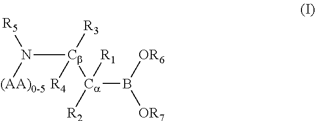

wherein R₁ and R₃ are preferably hydrogen; R₂ and R₄, which may be the same or different, are hydrogen, C₁₋₆ alkyl (including branched and cycloalkyl groups), optionally substituted by an aryl group which may itself be substituted, the substituent group including an alkyl (e.g. C₁₋₃) or —OR group in which R is C₁₋₃ alkyl, with one or more hydrogen atoms optionally replaced with a halogen atom, preferably F; or an aryl group which may be substituted, the substituent group including an alkyl (e.g. C₁₋₃) or —OR group in which R is C₁₋₃ alkyl, with one or more hydrogen atoms optionally replaced with a halogen atom, preferably F;

the atom of R₄ which is attached to C_{β} is either a saturated carbon atom or an atom, preferably a carbon atom, which is part of a substituted aromatic ring;

preferably one of R₂ and R₄ is hydrogen but R₁₋₄ are never all hydrogen;

if R₂ or R₄ is methyl then preferably the other is methyl or a larger group, more preferably a group larger than methyl;

R₂ and/or R₄ are preferably hydrogen, C₁₋₆ alkyl (e.g. methyl), phenethyl, benzyl, 4-(F)-benzyl, 4-(CF₃O)-benzyl, 2-naphthylmethyl or phenyl, more preferably a group containing one or more fluorine atoms or benzyl;

R₂ preferably contains no more than 8 non-hydrogen atoms;

R₅ is hydrogen or C₁₋₃ alkyl, when AA=0 then R₅ may form a cyclic group with the N-terminal capping group;

R₆ and R₇ independently of one another denote hydrogen or C₁₋₆ alkyl; or together with the boron atom and the oxygen atoms, form a mono-, bi- or tricyclic, saturated or partly unsaturated, mono-, di-, tri- or tetra-C₁₋₆alkylated or phenylated ring system having 5-18 ring members;

(AA)₀₋₅ is an amino acid, amino acid derivative, peptide of up to 5 amino acids or a peptidomimetic thereof which optionally incorporates an N-terminal capping group, where the group is (AA)₀ (i.e. no amino acids are present) then an N-terminal capping group is present, covalently attached to the nitrogen atom shown in formula (I) and the capping group comprises at least 5, preferably at least 6 or 7, non-hydrogen atoms, preferred amino acids or amino acid derivatives include lysine, arginine, alanine, proline, asparagine, aspartic acid, phenylalanine, tryptophan or homologues thereof such as homolysine, ornithine, diaminobutyric acid, diaminopimelic acid, diaminopropionic acid, trimethyllysine and homoarginine;

(AA)₁₋₂ is preferred (i.e. one or two amino acids or derivatives or equivalent subunits are present);

when the moiety is (AA)₁₋₅, i.e. a peptide or peptidomimetic of 1-5 amino acids or equivalent subunits is present, it is preferably attached to the rest of the molecule by an amide bond, as shown for example in formulae (IV) and (V) but amide bond replacements, e.g. mimetics of the amide bond may also be used;

as well as salt forms thereof;

but not including the compound

(i) 2-thiophenepropanamide, N-[1-[[[1-(cyclohexyl methyl)-5-methyl-2-(4,4,5,5-tetramethyl-1,3,2-dioxaborolan-2-yl)hexyl]amino]carbonyl]butyl]-α-[[(1,1-dimethylethyl)sulfonyl]methyl]-(CAS No.=130676-82-3).

The “aryl” group may contain one or more aromatic rings, preferably 1 or 2 aromatic rings, which rings may be fused e.g. naphthyl. The aromatic rings may contain heteroatoms, in particular nitrogen, e.g. pyridyl.

C₁₋₆ alkyl groups are preferably C₁₋₄ alkyl groups, more preferably C₁₋₃ alkyl groups.

Suitable esters of formula (I) include esters of pinanediol and pinacol. Thus “AA” represents an amino acid or an equivalent subunit in a peptidomimetic. The amino acid part of the moiety (AA)₀₋₅ may be L or D, preferably of the D form and they may be α, β or γ amino acids.

The compounds above may be α or β substituted or di-substituted, with a-substituted compounds being preferred.

All potential stereoisomers of compounds of formula (I) are contemplated and within the scope of the present invention. Stereoisomers include enantiomers and diastereomers e.g. geometric isomers.

Depending on the environment, compounds of the invention may be protonated, in particular at the N atom covalently attached to R₅.

Suitable N-terminal capping groups, in particular for peptide based pharmaceuticals are known in the art. Typically such groups are used to increase stability of the molecule in vivo. Suitable N terminal groups incorporate a group R which may be C₁₋₂₀ alkyl, optionally a saturated cyclic or polycyclic group in which a polycyclic group is preferably fused or bridged. R may be phenyl or another aryl group or a C₁₋₆ alkyl substituted by an aryl group, R may be attached directly to the N-terminal nitrogen or via a linking moiety to form a moiety RCO—, ROCO—, RNHCO—, R₂NCO— or via a linker which forms a sulfonamide or phosphonamide. R is preferably methyl, ethyl or benzyl. The capping group RCO— is preferred, preferably in which R is C₁₋₆ alkyl. In general, the N-terminal capping group may be aliphatic, branched aliphatic or aromatic. The N-terminal capping group may incorporate a basic, acidic, amide, hydroxyl or sulfhydryl moiety and the presence of such a moiety is preferred in the case that a group (AA)₀ is present, i.e. no amino acids are incorporated.

The compounds of formula (I) may be categorised as peptides or they may be peptidomimetics. A peptidomimetic is typically characterised by retaining the polarity, three dimensional size and functionality of its peptide equivalent but wherein the peptide bonds have been replaced, often by more stable linkages. By ‘stable’ is typically meant more resistant to enzymatic degradation by hydrolytic enzymes. Generally, the bond which replaces the amide bond (amide bond surrogate) conserves many of the properties of the amide bond, e.g. conformation, steric bulk, electrostatic character, possibility for hydrogen bonding etc. Chapter 14 of “Drug Design and Development”, Krogsgaard, Larsen, Liljefors and Madsen (Eds) 1996, Horwood Acad. Pub provides a general discussion of techniques for the design and synthesis of peptidomimetics. Suitable amide bond surrogates include the following groups: N-alkylation (Schmidt, R. et al., Int. J. Peptide Protein Res., 1995, 46, 47), retro-inverse amide (Chorev, M and Goodman, M., Acc. Chem. Res, 1993, 26, 266), thioamide (Sherman D. B. and Spatola, A. F. J. Am. Chem. Soc., 1990, 112, 433), thioester, phosphonate, ketomethylene (Hoffman, R. V. and Kim, H. O. J. Org. Chem., 1995, 60, 5107), hydroxymethylene, fluorovinyl (Allmendinger, T. et al., Tetrahydron Lett., 1990, 31, 7297), vinyl, methyleneamino (Sasaki, Y and Abe, J. Chem. Pharm. Bull. 1997 45, 13), methylenethio (Spatola, A. F., Methods Neurosci, 1993, 13, 19), alkane (Lavielle, S. et. al., Int. J. Peptide Protein Res., 1993, 42, 270) and sulfonamido (Luisi, G. et al. Tetrahedron Lett. 1993, 34, 2391).

Suitable peptidomimetics include reduced peptides where the amide bond has been reduced to a methylene amine by treatment with a reducing agent e.g. borane or a hydride reagent such as lithium aluminium hydride. Such a reduction has the added advantage of increasing the overall cationicity of the molecule.

Other peptidomimetics include peptoids formed, for example, by the stepwise synthesis of amide-functionalised polyglycines. Some peptidomimetic backbones will be readily available from their peptide precursors, such as peptides which have been permethylated, suitable methods are described by Ostresh, J. M. et al. in Proc. Natl. Acad. Sci. USA 1994, 91, 11138-11142. Strongly basic conditions will favour N-methylation over O-methylation and result in methylation of some or all of the nitrogen atoms in the peptide bonds and the N-terminal nitrogen.

Preferred peptidomimetic backbones include polyesters, polyamines and derivatives thereof as well as substituted alkanes and alkenes.

Preferred compounds of the invention are represented by the following formulae (II) and (III) and thus in a further aspect the present invention provides a compound of formula (II)

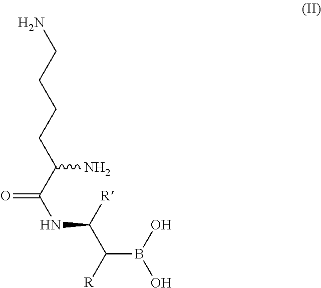

or formula (III)

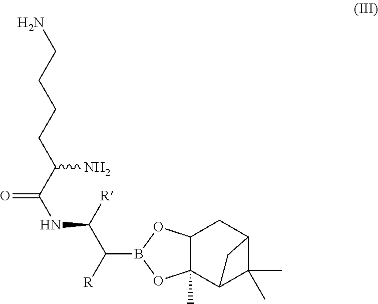

in which R and R′, which may be the same or different, are hydrogen, C₁₋₆ alkyl (including branched and cycloalkyl groups), optionally substituted by an aryl group which may itself be substituted, the substituent group including an alkyl (e.g. C₁₋₃) or —OR group in which R is C₁₋₃ alkyl, with one or more hydrogen atoms optionally replaced with a halogen atom, preferably F; or an aryl group which may be substituted, the substituent group including an alkyl (e.g. C₁₋₃) or —OR group in which R is C₁₋₃ alkyl, with one or more hydrogen atoms optionally replaced with a halogen atom, preferably F.

Both the alpha and beta carbon atoms may be substituted but preferably one of R and R′ is hydrogen and the other is as defined above, preferably it is C₁₋₆ alkyl (e.g. methyl), phenethyl, benzyl, 4-(F)-benzyl, 4-(CF₃O)-benzyl, 2-naphthylmethyl or phenyl, most preferably a group containing one or more fluorine atoms or benzyl.

Compounds of formulae (II) and (III) incorporate the amino acid lysine but this may be replaced with one or more alternative amino acids or amino acid derivatives or short peptides, e.g. of 1-5 amino acids or amino acid derivatives, or a peptidomimetic thereof, represented in the following formulae (IV) and (V) by R″. Preferred amino acids are lysine, arginine, alanine, phenylalanine, proline, asparagine, aspartic acid and tryptophan or homologues thereof such as homolysine, ornithine, diaminobutyric acid, diaminopimelic acid, diaminopropionic acid, trimethyllysine and homoarginine.

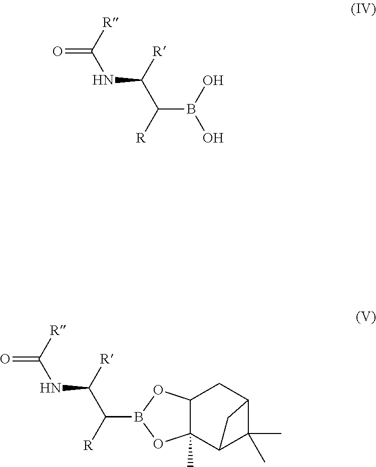

More generally therefore, a preferred group of compounds of the invention is represented by formula (VI)

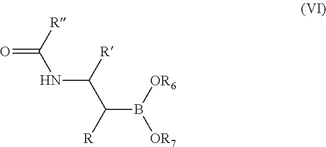

in which R, R′, R″, R₆ and R₇ are as defined above.

Of the compounds of the invention, the borates are generally preferred to the boric acids.

A further series of molecules have also been found to display good activity against Mycobacterium tuberculosis. Thus in a further aspect, the present invention provides a compound of formaula (VII)

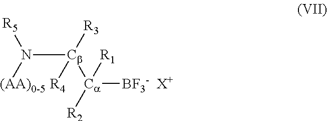

In which the R group substituents are as defined above and X+is a counterion, e.g. Na⁺ or K⁺.

Particularly preferred compounds of the invention are shown in Table 1 herein.

In a further aspect is provided the compounds of the present invention for use in therapy, particularly for use as an antibacterial or antifungal agent, the compounds for use including the compound disclaimed above, in particular as agents for the treatment or prevention of an MTB infection or for the treatment of TB.

Methods of treating or preventing a bacterial or fungal infection, in particular an MTB infection, which comprise administration to a human or animal patient one or more of the compounds as defined herein, as well as the compound disclaimed above, constitute further aspects of the present invention. The patient will typically have been identified as in need of such treatment. Treatments may be prophylactic but generally will not be. A prophylactic treatment is one where no positive diagnosis of an infection has been made. The treatments may be performed when an infection has been confirmed but no symptoms expressed, in order to prevent activation of the infection, or after symptoms have been observed.

A preferred fungal target is Candida albicans. Overgrowth of C. albicans can lead to candidiasis, e.g. thrush in the mouth or vagina, and is often observed in immunocompromised individuals. Such patients being a preferred target group for treatments according to the present invention. Compounds of the present invention have been shown to be highly effective against strains of C. albicans which exhibit resistance to common antifungal agents such as nystatin and/or fluconazole. Thus in a preferred embodiment, the present invention provides compounds for use in treating a C. albicans infection, particularly an infection which shows drug resistance e.g. to nystatin and/or fluconazole. Preferred compounds for use against C. albicans are α-substituted, β-aminoboronates, preferably the α-substituent includes a mono or di-cyclic group, e.g. a naphthyl group.

Methods of diagnosing an MTB infection or diagnosing TB are known in the art. For example, sputum may be taken on three successive mornings, as the number of organisms could be low, and the specimen treated with 3% KOH or NaOH for liquefaction and decontamination. A grading system exists for interpretation of the microscopic findings based on the number of organisms observed. The bacteria can be visualized by fluorescent microscopy using an auramine-rhodamine stain.

MTB is traditionally grown on a selective medium, e.g. Lowenstein-Jensen medium. However, this method is quite slow as the organism requires six to eight weeks to grow, which delays reporting of results. A faster result can be obtained using Middlebrook medium or BACTEC. Using BACTEC, growth may be detected in about a week using a culture media containing C-14 labelled palmitic acid. Mycobacteria metabolise this substrate and release radioactively labelled carbon dioxide. The instrument measures labelled carbon dioxide and reports in terms of a ‘growth index’. A growth index of 10 or more is considered as positive.

Another rapid method for the detection of MTB utilises a Mycobacterial growth indicator tube (MGIT). It is a non-radiometric, automated method which consists of tubes containing liquid culture media with a fluorescent compound embedded on the bottom of the tube. The fluorescent compound is sensitive to the dissolved oxygen in the liquid medium. When mycobacteria grow, they deplete the dissolved oxygen in the liquid medium and this allows the compound to fluoresce brightly which can be detected by observing the tube under UV light. The results are obtained in 8 to 14 days.

Animals which may be treated include domestic animals, in particular cats and dogs and livestock animals such as pigs, cows, sheep or goats as well as horses, also elephants. Treatment of humans is nevertheless preferred.

Methods of making compounds of the present invention are described in the Examples; methods of synthesising compounds of the invention, in particular methods described in the Examples, constitute a further aspect of the present invention. The compounds of the invention may comprise a peptide or peptide-like component. Peptides may be synthesised in any convenient way. Generally the reactive groups present (for example amino, thiol and/or carboxyl) will be protected during overall synthesis. The final step in the synthesis will thus be the deprotection of a protected derivative of the invention.

In building up the peptide, one can in principle start either at the C-terminal or the N-terminal although the C-terminal starting procedure is preferred. Methods of peptide synthesis are well known in the art, for the present invention it may be convenient to carry out the synthesis on a solid phase support, such supports being well known in the art.

A wide choice of protecting groups for amino acids are known and suitable amine protecting groups may include carbobenzoxy (also designated Z) t-butoxycarbonyl (also designated Boc), 4-methoxy-2,3,6-trimethylbenzene sulphonyl (Mtr) and 9-fluorenylmethoxy-carbonyl (also designated Fmoc). It will be appreciated that when the peptide is built up from the C-terminal end, an amine-protecting group will be present on the α-amino group of each new residue added and will need to be removed selectively prior to the next coupling step.

A wide range of procedures exists for removing amine- and carboxyl-protecting groups. These must, however, be consistent with the synthetic strategy employed. The side chain protecting groups must be stable to the conditions used to remove the temporary a-amino protecting group prior to the next coupling step.

Amine protecting groups such as Boc and carboxyl protecting groups such as tBu may be removed simultaneously by acid treatment, for example with trifluoroacetic acid. Thiol protecting groups such as Trt may be removed selectively using an oxidation agent such as iodine.

References and techniques for synthesising peptidomimetic compounds and the other bioactive molecules of the invention are described herein and thus are well known in the art.

Formulations comprising one or more compounds of the invention in admixture with a suitable diluent, carrier or excipient constitute a further aspect of the present invention. Such formulations may be for pharmaceutical or veterinary use. Suitable diluents, excipients and carriers are known to the skilled man.

The compositions according to the invention may be presented, for example, in a form suitable for oral, nasal, parenteral, intravenal, topical or rectal administration.

As used herein, the term “pharmaceutical” includes veterinary applications of the invention.

The active compounds defined herein may be presented in the conventional pharmacological forms of administration, such as tablets, coated tablets, nasal sprays, inhalers, solutions, emulsions, liposomes, powders, capsules or sustained release forms.

Conventional pharmaceutical excipients as well as the usual methods of production may be employed for the preparation of these forms. Tablets may be produced, for example, by mixing the active ingredient or ingredients with known excipients, such as for example with diluents, such as calcium carbonate, calcium phosphate or lactose, disintegrants such as corn starch or alginic acid, binders such as starch or gelatin, lubricants such as magnesium stearate or talcum, and/or agents for obtaining sustained release, such as carboxypolymethylene, carboxymethyl cellulose, cellulose acetate phthalate, or polyvinylacetate.

The tablets may if desired consist of several layers. Coated tablets may be produced by coating cores, obtained in a similar manner to the tablets, with agents commonly used for tablet coatings, for example, polyvinyl pyrrolidone or shellac, gum arabic, talcum, titanium dioxide or sugar. In order to obtain sustained release or to avoid incompatibilities, the core may consist of several layers too. The tablet coat may also consist of several layers in order to obtain sustained release, in which case the excipients mentioned above for tablets may be used.

Injection solutions may, for example, be produced in the conventional manner, such as by the addition of preservation agents, such as p-hydroxybenzoates, or stabilizers, such as EDTA. The solutions are then filled into injection vials or ampoules.

Nasal sprays administration may be formulated similarly in aqueous solution and packed into spray containers either with an aerosol propellant or provided with means for manual compression.

Capsules containing one or several active ingredients may be produced, for example, by mixing the active ingredients with inert carriers, such as lactose or sorbitol, and filling the mixture into gelatin capsules.

Suitable suppositories may, for example, be produced by mixing the active ingredient or active ingredient combinations with the conventional carriers envisaged for this purpose, such as natural fats or polyethyleneglycol or derivatives thereof.

Inhalers suitable for delivery of the compounds of the invention, e.g. in dry powder form, may be of the Turbuhaler® type.

Dosage units containing the active molecules preferably contain 0.1-10mg, for example 1-5mg of the active agent. The pharmaceutical compositions may additionally comprise further active ingredients, including other cytotoxic agents. Other active ingredients may include different types of antibiotics, cytokines e.g. IFN-γ, TNF, CSF and growth factors, immunomodulators, chemotherapeutics e.g. cisplatin or antibodies.

In employing such compositions systemically (intra-muscular, intravenous, intraperitoneal), the active molecule is generally present in an amount to achieve a serum level of the bioactive molecule of at least about 5 μg/ml. In general, the serum level need not exceed 500 μg/ml. A preferred serum level is about 20-100 μg/ml. Such serum levels may be achieved by incorporating the bioactive molecule in a composition to be administered systemically at a dose of from 1 to about 10 mg/kg. In general, the molecule(s) need not be administered at a dose exceeding 100 mg/kg.

Therapeutically effective amounts can be readily determined with reference to known methods of monitoring MTB infections and symptoms thereof. It being appreciated that appropriate dosage will vary from patient to patient dependent on age, duration of infection, previous treatment attempts, severity of symptoms presented etc.

The above description describes numerous features of the present invention and in most cases preferred embodiments of each feature are described. It will be appreciated that each preferred embodiment of a given feature may provide a molecule, use, method etc. of the invention which is preferred, both when combined with the other features of the invention in their most general form and when combined with preferred embodiments of other features. The effect of selecting multiple preferred embodiments may be additive or synergistic. Thus all such combinations are contemplated unless the technical context obviously makes them mutually exclusive or contradictory. In general each feature and preferred embodiments of it are independent of the other features and hence combinations of preferred embodiments may be presented to describe sub-sets of the most general definitions without providing the skilled reader with any new concepts or information as such.

The invention will now be further described with reference to the following non-limiting Examples.

### EXAMPLES

### Synthesis of Compounds of the Invention

Reaction schemes for different classes of molecule within the scope of the present invention are set out below and are followed by experimental details for the different reaction steps.

### Synthesis of α-Substituted β-Aminoboronates

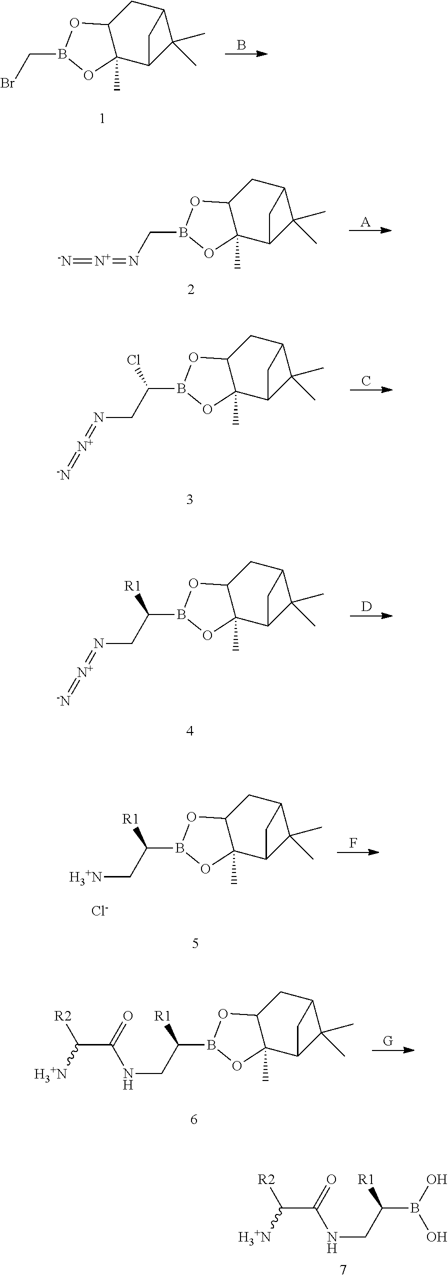

The identity of substituents equivalent to R1 and R2 are discussed herein in the definitions of the compounds of the invention and the compounds of Table 1 show what compounds have been made and thus the identity of R1 and R2 in the compounds synthesised.

### Synthesis of β-Substituted β-Aminoboronates

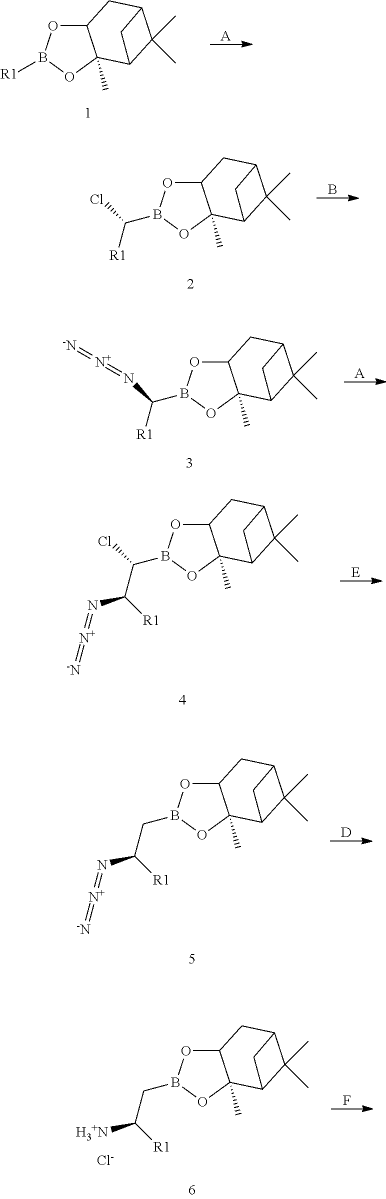

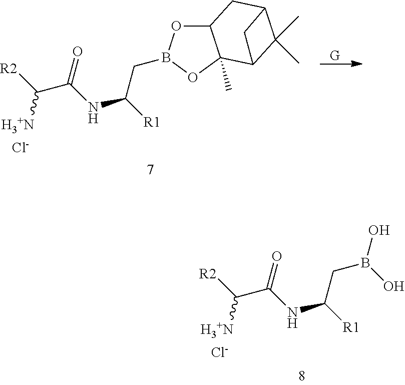

The identity of substituents equivalent to R1 and R2 are discussed herein in the definitions of the compounds of the invention and the compounds of Table 1 show what compounds have been made and thus the identity of R1 and R2 in the compounds synthesised.

### Synthesis of α,β-Disubstituted β-Aminoboronates

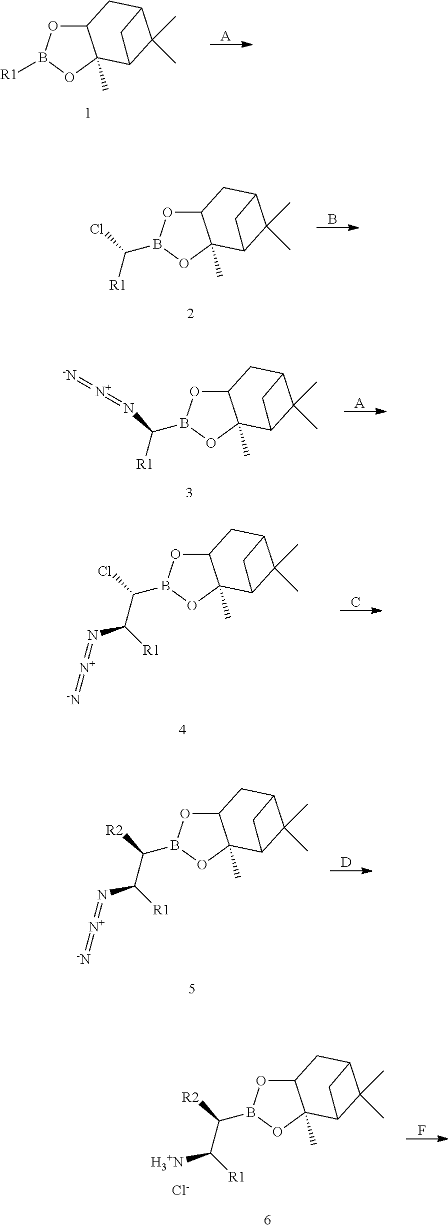

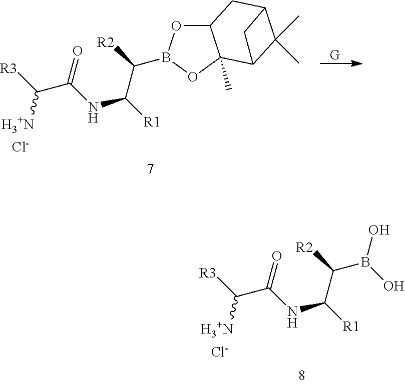

The identity of substituents equivalent to R1, R2 and R3 are discussed herein in the definitions of the compounds of the invention and the compounds of Table 1 show what compounds have been made and thus the identity of R1, R2 and R3 in the compounds synthesised.

### Synthesis of BF₃K-Salts of β-Substituted β-Aminoboronates

Synthesis of BF₃K-salts of β-aminoboronates was carried out following the scheme below:

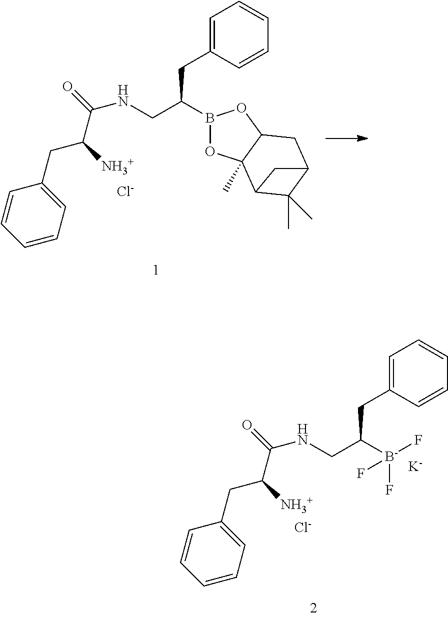

To the stirred solution of boronate (1 eq) in methanol was added a 4.5 M solution of potassium hydrogen difluoride (10 eq). The resulting mixture was stirred for 1 hr at room temperature and concentrated to dryness (all manipulations have to be done in the hood as potassium hydrogen difluoride is corrosive and hydrogen fluoride is highly toxic). The dry residue was boiled in acetone and the precipitate was filtered off. Solution was concentrated under vacuum to give final product (10% yield).

(Inglis et al. J. Org. Chem. Vol. 75, No. 2, 2010)

### Reaction Type A

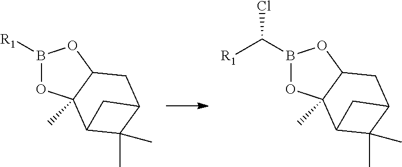

(Dichloromethyl)lithium was prepared by the dropwise addition of n-butyllithium (2.27 g, 13 mL, 2.7 M solution in n-hexane, 0.035 mol, 1.3 eq.) to a solution of dried dichloromethane (4.6 g, 0.054 mol, 2 eq.) in 70 mL of anhydrous tetrahydrofuran at −100° C. under argon. After addition of 90% of the n-butyllithium a white precipitate formed. A solution of boronate (R1=benzyl, 7.25 g, 0.027 mol, 1 eq.) in 20 mL of dry tetrahydrofuran was slowly added to the vigorously stirred slurry of dichloromethyllithium. After 10 min the reaction temperature was raised to −78° C. and the mixture was stirred for an additional 30 min.

An anhydrous zinc chloride solution (5.5 g, 40.4 mL of 1 M solution in diethyl ether, 0.4 mol, 1.5 eq.) was then added dropwise over 5 min. and the mixture was allowed to warm to room temperature.

After 2 hrs of stirring diethyl ether (50 mL) was added to the reaction mixture and the suspension obtained was washed with saturated ammonium chloride. The solvent was evaporated and the oily residue was dissolved in pentane (30 mL), washed with brine and dried over magnesium sulfate. Pentane was removed under vacuum to obtain the product containing approximately 5% of starting material as oil. m=8.3 g (97% yield)

### Reaction Type B

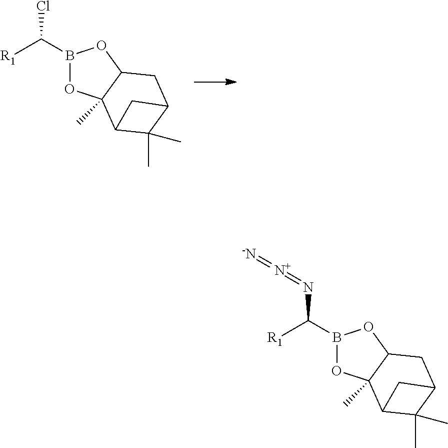

Starting boronate (8.3 g, 0.026 mol) was added as a dichloromethane solution (100 mL) dropwise over 40 min to the two-phase system (350 mL, dichloromethane/water 2.5/l) containing sodium azide (17 g, 0.26 mol) and tetrabutylammonium bromide (0.42 g, 0.0013 mol). The reaction mixture was stirred overnight at room temperature. The organic phase was separated and concentrated under vacuum. n-Pentane (50 mL) was added to the oily residue and the solution was washed with saturated aqueous ammonium chloride. The organic phase was separated, filtered quickly through a pad of celite and dried over magnesium sulfate. The solution was concentrated under vacuum to obtain oily product. m=8.0 g (94% yield).

### Reaction Type A

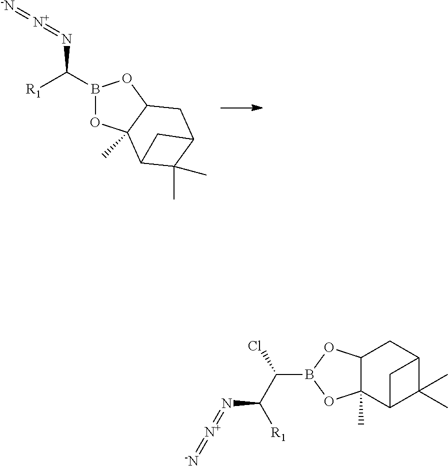

(Dichloromethyl)lithium was prepared by the dropwise addition of n-butyllithium (2.0 g, 11.4 mL 2.7 M solution in n-hexane, 0.03 mol, 1.3 eq.) to a solution of dried dichloromethane (4.0 g, 0.047 mol, 2 eq.) in 70 mL of anhydrous tetrahydrofuran at −100° C. under argon. After addition of 90% of the n-buthyllithium a white precipitate of (dichloromethyl)lithium formed. A solution of boronate (7.6 g, 0.0233 mol, 1 eq.) in 20 mL of dry tetrahydrofuran was slowly added to the vigorously stirred slurry of dichloromethyllithium. After 10 min the reaction temperature was raised to −78° C. and the mixture was stirred for an additional 30 min.

An anhydrous zinc chloride solution (4.8 g, 35.3 mL of 1 M solution in diethyl ether, 0.035 mol, 1.5 eq.) was then added dropwise over 5 min and the mixture was allowed to warm to room temperature.

After 2 hrs of stirring diethyl ether (50 mL) was added to the reaction mixture and the suspension obtained was washed with saturated ammonium chloride. The solvent was evaporated and the oily residue was dissolved in pentane (30 mL), washed with brine and dried over magnesium sulfate. Pentane was removed under vacuum to obtain the product as an oil. m=7.1 g (81% yield)

### Reaction Type E

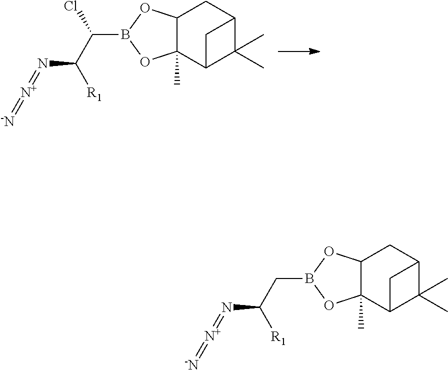

A solution of the a-chloro derivative of the boronate (5 g, 0.0133 mol, 1 eq) in dry tetrahydrofuran (50 mL) was cooled to −78° C. and a solution of lithium triethylborohydride (1.84 g, 0.0173 mol, 17.3 mL of 1M sol. in tetrahydrofuran, 1.3 eq) was added dropwise to the vigorously stirred solution. The reaction mixture was stirred overnight, concentrated under vacuum and the residue was dissolved in diethyl ether, washed with saturated ammonium chloride and dried over magnesium sulfate. The dried solution was concentrated under vacuum to give pure product. m=4.0 g (88.9% yield)

### Reaction Type D

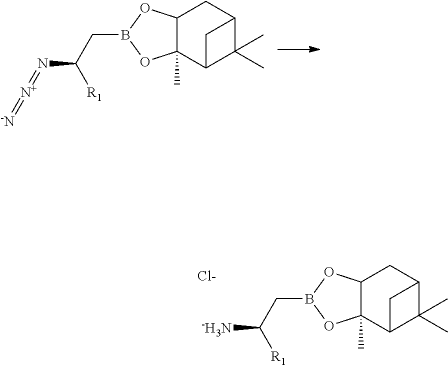

β-azidoboronate (4.0 g, 0.117 mol, 1 eq.) was dissolved in dry tetrahydrofuran (20 mL) and cooled to −78° C. To the solution of β-azidoboronate solution of lithium aluminum hydride (0.54 g, 0.0142 mol, 7.1 mL 2 M solution in tetrahydrofurane, 1.2 eq.) was added dropwise and the resulting mixture was allowed to warm to room temperature and stirred overnight. Water was added slowly to the reaction mixture to remove unreacted lithium aluminum hydride. Forming white precipitate was filtered off and washed several times with diethyl ether. Organic layers were combined, washed with saturated ammonium chloride solution and dried over magnesium sulfate. The solution was concentrated under vacuum and dissolved in pentane (30 mL). The precipitate (if present) was filtered off. The solution was concentrated under vacuum to give the product as an oil. m=3.0 g (62% yield) To the solution of amine excess of 1.25 M solution of hydrochloric acid in methanol was added at Ot and the resulting mixture was stirred overnight at room temperature. Solvents were evaporated and the residue was washed with pentane to give pure aminoboronate hydrochloride in quantitative yield.

### Reaction Type F

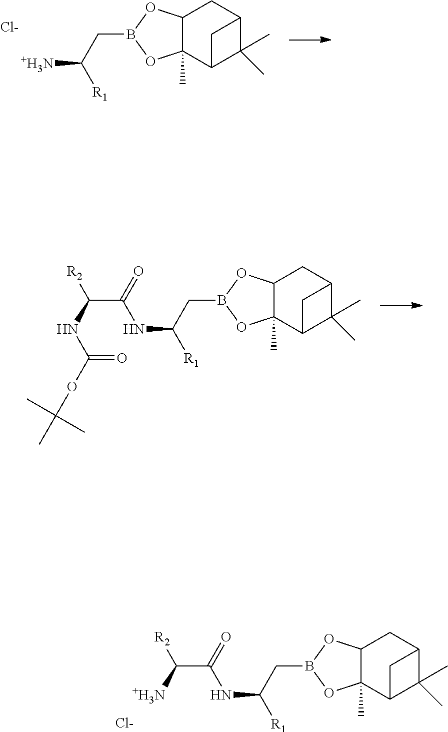

To a stirred, ice-cold solution of Boc-protected amino acid (0.23 g, 0.00086 mol, 1 eq) in dichloromethane (5 mL) was added 1-hydroxybenzotriazole hydrate (0.14 g, 0.00086 mol, 1 eq) and N-(3-dimethylaminopropyl)-N′-ethylcarbodiimide (0.0011 mol, 1.3 eq). After 30 min a solution of aminoboronate hydrochloride (0.3 g, 0.00086 mol, 1 eq) was added followed by N-methylmorpholine (0.174 g, 0.0017 mol, 2 eq). The mixture was allowed to warm slowly to room temperature and was stirred for 8 hrs. The solution was washed with water, 1 M potassium hydrogensulfate and saturated sodium bicarbonate consecutevely. The organic solution was filtered through a pad of silica gel with ethyl acetate as eluent. The resulting solution was evaporated to give pure product. m=0.3 g (63% yield)

### Amine Deprotection

Protected dipeptide (0.26 g) was dissolved in MeOH (3 mL) treated with a 5-fold excess of 1.25 M solution of hydrochloric acid in methanol at 0° C. for 1 hr. Solvents were removed under vacuum, the residue was washed with diethyl ether and the solids were dried under vacuum to give pure product. m=0.2 g (95% yield) Snow et al. J. Am. Chem. Soc. 1994, 116, 10860-10869

### Reaction Type G

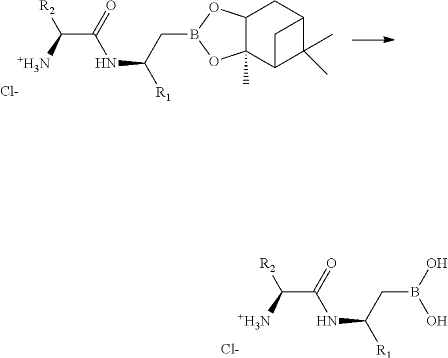

The diol was removed by one of two following procedures:
A: Dipeptide (0.1 g, 0.00022 mol) was stirred at 90° C. in hydrochloric acid (5 mL of 3 M solution) for 1 hr. The reaction mixture was cooled to room temperature extracted with dichloromethane (3_{—}10 mL) and the water layer was concentrated under vacuum to give the product as a white precipitate. m=0.05 g (70.4% yield)
B: To a solution of dipeptide (1 eq) in (6 mL per 100 mg of peptide) diethyl ether/water (1:1) phenylboronic acid (4 eq) was added. The reaction mixture was stirred for 10 hrs. The aqueous layer was separated, washed with diethyl ether (3_{—}3 mL) and concentrated under vacuum to give pure product in quantitative yield. Wityak J., et al. The Journal of Organic Chemistry 1995, 60, 3717-3722.

### Reaction Type A

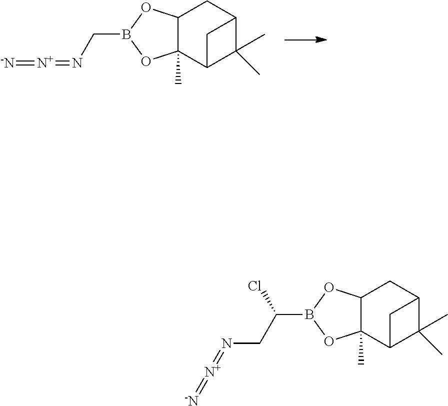

(Dichloromethyl)lithium was prepared by the dropwise addition of n-butyllithium (1.96 g, 11.2 mL 2.7 M solution in n-hexane, 0.03 mol, 1.2 eq) to a solution of dried dichloromethane (4.34 g, 0.051 mol, 2 eq) in 60 mL of anhydrous tetrahydrofuran at −100° C. under argon. After addition of 90% of n-butyllithium a white precipitate of (dichloromethyl)lithium formed. A solution of boronate (6.0 g, 0.0255 mol, 1 eq) in 20 mL of dry tetrahydrofuran was slowly added to the vigorously stirred slurry of dichloromethyllithium. After 10 min the reaction temperature was raised to −78° C. and the mixture was stirred for an additional 30 min.

Anhydrous zinc chloride solution (5.2 g, 38.3 mL of 1 M solution in diethyl ether, 0.38 mol, 1.5 eq) was then added dropwise over 5 min and the mixture was allowed to warm to room temperature.

After 2 hrs of stirring diethyl ether (50 mL) was added to the reaction mixture and the suspension obtained was washed with saturated ammonium chloride. The solvent was evaporated and the oily residue was dissolved in pentane (30 mL), washed with brine and dried over magnesium sulfate. Pentane was removed under vacuum to obtain the product containing approximately 5-7% of starting material as an oil. m=6.1 g (84.7% yield)

### Reaction Type C

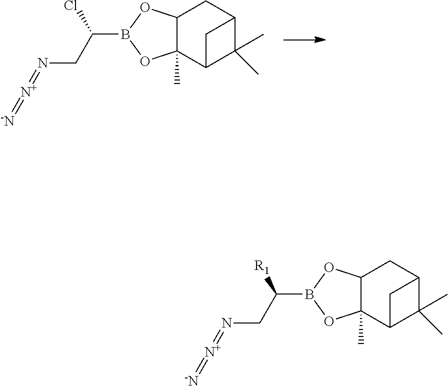

Grignard reagent (methylmagnesium chloride: 0.96 g, 4.3 mL 3 M solution in tetrahydrofuran, 0.0128 mol, 1.2 eq) was added dropwise to the cooled solution of α-chloroalkylboronate (3.0 g, 0.0106 mol, 1eq) in tetrahydrofuran at −78° C. The reaction mixture was stirred for 30 min. A zinc chloride solution (5.8 g, 42.6 mL 1 M solution in diethyl ether, 0.0426 mol, 4 eq) was added dropwise to the reaction mixture; the solution was allowed to warm to room temperature and stirred overnight. The reaction mixture was concentrated under vacuum, dissolved in pentane and washed with saturated ammonium chloride solution. The organic layer was dried over magnesium sulfate and concentrated under vacuum to obtain the product as colorless oil. m=2.4 g, (86% yield)

### Reaction Type D

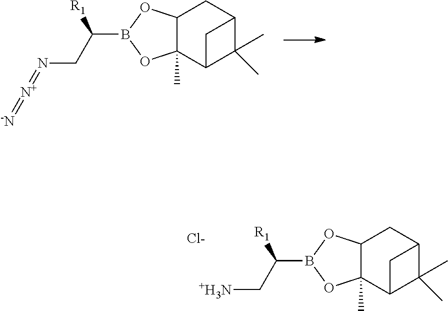

β-azidoboronate (4.1 g, 1 eq) was dissolved in dry tetrahydrofuran (20 ml) and cooled to −78° C. To the solution lithium aluminum hydride (0.71 g, 0.0186 mol, 9.3 mL 2 M solution in tetrahydrofuran, 1.2 eq) was added dropwise and the resulting mixture was allowed to warm to room temperature and stirred overnight. Water was added slowly to the reaction mixture to decompose unreacted lithium aluminum hydride. The white precipitate was filtered off and washed several times with diethyl ether. Organic layers were combined, washed with saturated ammonium chloride solution and dried over magnesium sulfate. The solution was concentrated under vacuum and dissolved in pentane. The prcipitate (if present) was filtered off. To the solution of amine an excess of hydrochloric acid (1.25 M solution in methanol) was added at 0° C. and the resulting mixture was stirred overnight at room temperature. Solvents were evaporated and the oily residue was washed with pentane. The solvent was decanted leaving 2.5 g of pure product (54.3% yield).

### Preferred Synthetic Method for β-Substituted β-Aminoboronate in Which the β-Substituent Is Phenyl

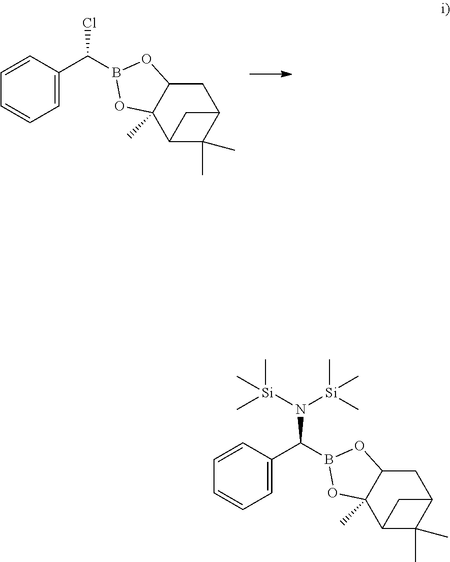 [SMILES: CC1(C)C2CC3OB([C@@H](Cl)c4ccccc4)O[C@]3(C)C1C2 ; CC1(C)C2CC3OB([C@@H](c4ccccc4)N([Si](C)(C)C)[Si](C)(C)C)O[C@]3(C)C1C2]

To a stirred solution of α-chloro derivative (9.5 g, 0.0312 mol, 1 eq) in dry tetrahydrofuran (50 mL) under argon lithium hexamethyldisilazane (6.25 g, 0.0374 mol, 37.7 mL 1 M solution in tetrahydrofuran 1.2 eq) was added dropwise over 20 min at −78° C. The reaction mixture was stirred overnight at room temperature. Solvents were removed under vacuum, the residue was dissolved in pentane, precipitate was filtered off and the solution was concentrated under vacuum to give a moisture sensitive oily residue (no starting material left according to NMR) which was used in the next step without further purification. m (crude)=14.7 g (more than 100%)

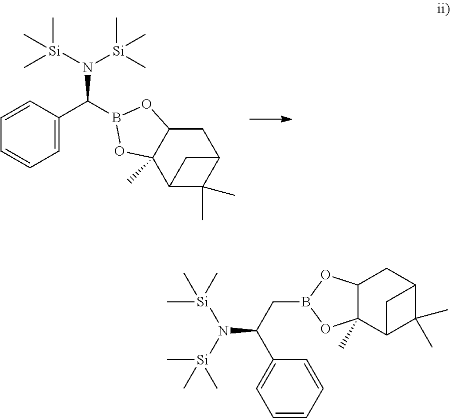

To a mixture of silylated α-aminoboronate (1.3 g, 0.003 mol, 1 eq) and chloroiodomethane (0.65 g, 0.0037 mol, 1.2 eq) in dry tetrahydrofuran (20 mL) under argon n-butyllithium (0.24 g, 0.0037 mol, 1.36 mL 2.7 M solution in n-hexane, 1.2 eq) was added dropwise over 10 min at −78° C. The reaction mixture was allowed to warm to room temperature and stirred overnight. The reaction mixture was concentrated under vacuum and the residue was dissolved in pentane. Precipitate was filtered of and the solution was concentrated under vacuum to give moisture sensitive oily residue. m=1.2 g (60% conversion to the final product according to NMR).

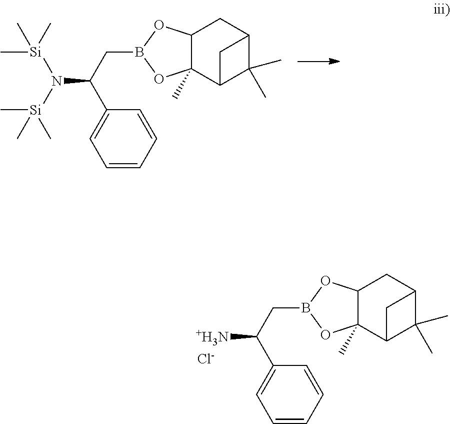

To a solution of silylated β-aminoboronate (1.2 g, 0.0027 mol, 1 eq) (mixture from previous step) in pentane (5 mL) solution of hydrochloric acid (0.2 g, 0.0054 mol, 1.4 mL 4 M solution in dioxane, 2 eq) was added at −78° C. dropwise over 5 min. A white precipitate formed. The resulting mixture was allowed to warm to room temperature and stirred overnight. The solvent was evaporated under vacuum, pentane was added to the residue, and precipitate was filtered and washed with pentane. To remove starting a-aminoboronate the crude product was converted to free amine and back to the hydrochloric salt. (As free a-aminoboronates are not stable and easily decompose, products of decomposition can be washed out from the hydrochloric salt of β-aminoboronate). m=0.45 g (49.6% yield).

### In Vitro Testing

### Antibacterial and Antifungal Activity of Compounds

Test organisms used were the bacterial strains Escherichia coli (ATCC 25922), Pseudomonas aeruginosa (ATCC 27853), Staphylococcus aureus (ATCC 25923), Streptococcus pyogenes (ATCC 19615), and Mycobacterium tuberculosis (H37Rv), and the yeast strain Candida albicans (ATCC 90028).

The liquid media used for growth were Luria-Bertani (Becton Dickinson, Sparks, Md.) and Mueller-Hinton (bio-Merieux, Paris, France) broths, but with Saburo medium for Candida and Middlebrook 7H9 medium (Difco) for mycobacteria.

The strains were grown at 37° C. and after suitable cell concentrations had been reached, 100 μL of each cell suspension was added to a tube with growth media and test compound. Cultivation of the bacteria was then carried out in the presence of each test compound at 37° C. and the tubes examined for visible growth. The compounds were tested at concentrations of either 500 mg/l, 50 mg/l or 5 mg/l. This assay was repeated twice.

In a further experiment, a sample of cells from the test tubes in which the above broth activity assays were performed were plated on agar to determine the presence of bacterial or fungal growth. The CFUs were counted.

### Results

Table 1 shows the chemical structures and the antimicrobial activity of the test compounds in liquid media. After cultivation in the presence of the compound (500, 50 or 5 mg/L), tested strains showed either microbial growth in all samples (+), microbial growth in some of the samples (±) or no microbial growth (−). Some compounds were only tested against some test organisms. It will be appreciated that the charge of these molecules will depend on the environment, some of the Examples are shown with a suitable counter ion, some without.

The results of the plating to determine CFUs were consistent with the liquid media results (data not shown).

TABLE 1

| | | | Growth in the |
|---|---|---|---|
| | | | presence of test |
| | | | compound |
| | | | concentrations of |
| | Chemical Structure | Reference No. | 500/50/5 mg/L |
| 1 | 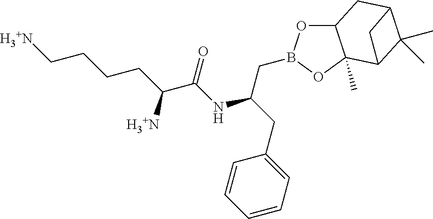 | tlg_132(1) | M. tuberculosis −−− S. aureus −++ E. coli −++ E. faecalis −++ P. aeruginosa ±++ |
| 2 | 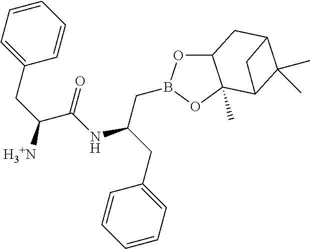 | tlg_110_620 | M. tuberculosis ±++ |
| 3 | 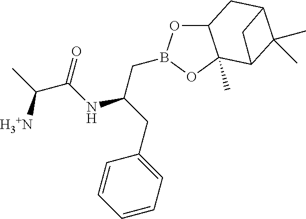 | tlg_111_644 | M. tuberculosis −−+ S. aureus −++ S. pyogenes −++ |
| 4 | 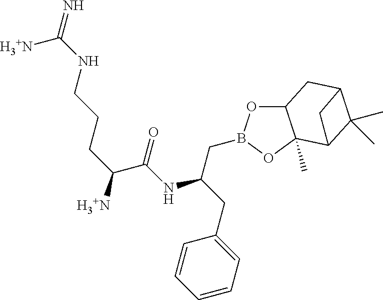 | tlg_224_624 | M. tuberculosis −−+ S. aureus −++ E. coli −++ S. pyogenes −++ C. albicans −++ |
| 5 | 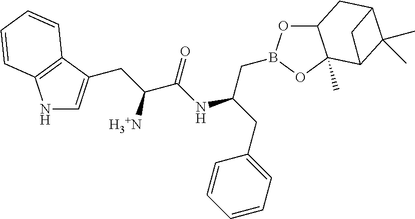 | tlg_229_636 | M. tuberculosis −±+ S. aureus −++ |
| 6 | 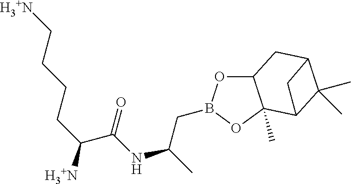 | tlo_227_463 | M. tuberculosis ±++ |
| 7 | 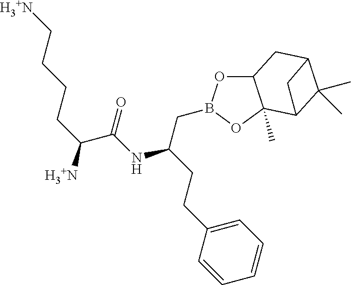 | tlo_254_490 | M. tuberculosis −++ S. aureus −++ E. coli −++ S. pyogenes −++ C. albicans −++ P. aeruginosa ±++ |
| 8 | 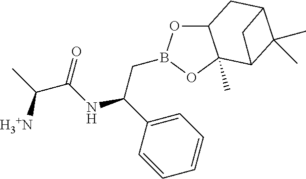 | tlg_204_550 | M. tuberculosis −++ S. aureus ±++ |
| 9 | 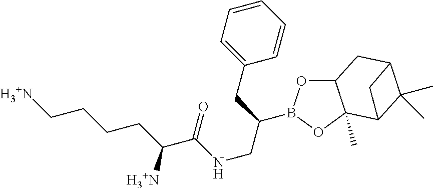 | tlg_228_634 | M. tuberculosis −−− S. aureus −++ S. pyogenes −++ C. albicans −++ P. aeruginosa ±++ |
| 10 | 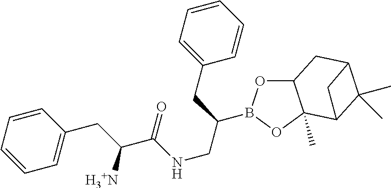 | tlg_227_632 | M. tuberculosis −−− S. aureus ±++ S. pyogenes ±++ C. albicans ±++ |
| 11 | 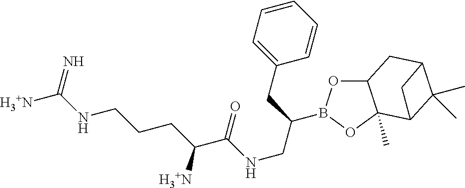 | tlg_260_718 | M. tuberculosis −−± S. aureus −++ E. coli −++ S. pyogenes −++ P. aeruginosa −++ C. albicans −++ |
| 12 | 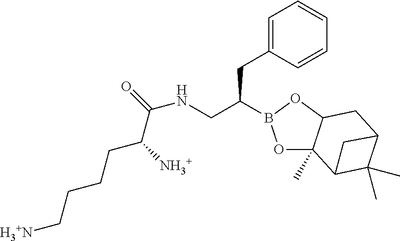 | tlo_260_496 | M. tuberculosis −−± S. aureus ±++ E. coli −++ P. aeruginosa ±++ S. pyogenes −++ C. albicans −++ |
| 13 | 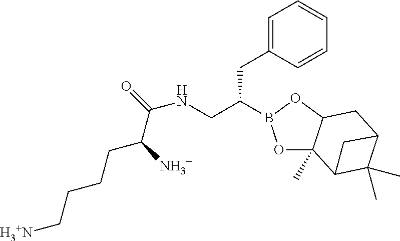 | tlg_258_714 | M. tuberculosis −−+ S. aureus −++ E. coli −++ P. aeruginosa −++ S. pyogenes −++ C. albicans −++ |
| 14 | 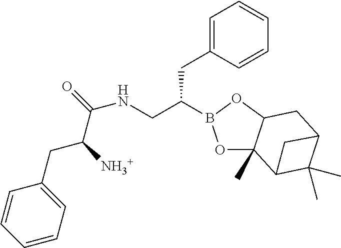 [SMILES: CC1(C)C2CC3OB([C@H](CNC(=O)[C@@H]([NH3+])Cc4ccccc4)Cc4ccccc4)O[C@@]3(C)C1C2] | tlo_225_461 | M. tuberculosis −−+ S. aureus +++ E. coli +++ P. aeruginosa −++ S. pyogenes ±++ C. albicans ±±+ |
| 15 | 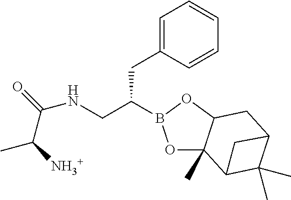 [SMILES: C[C@H]([NH3+])C(=O)NC[C@H](Cc1ccccc1)B1OC2CC3CC(C3(C)C)[C@]2(C)O1] | tlo_226_462 | M. tuberculosis −−+ S. aureus −++ E. coli ±++ P. aeruginosa +++ S. pyogenes +++ C. albicans −++ |
| 16 | 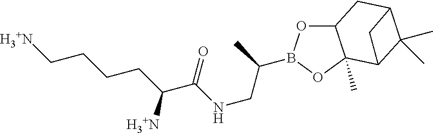 | tlg_251_700 | M. tuberculosis −±+ C. albicans ±++ |
| 17 | 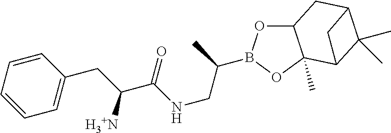 | tlg_252_702 | M. tuberculosis −++ S. aureus −++ S. pyogenes −++ C. albicans ±++ |
| 18 | 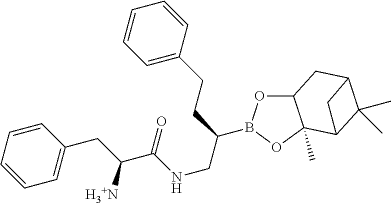 | tlo_243_479 | M. tuberculosis −−+ S. aureus ±−+ E. coli +++ P. aeruginosa ±±+ S. pyogenes ±±+ C. albicans ±±+ |
| 19 | 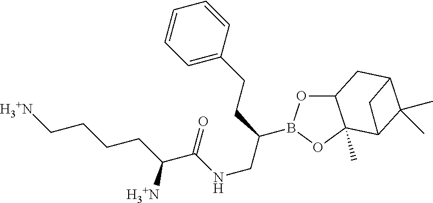 | Tlo_246_482_1 | M. tuberculosis −−+ S. aureus ±++ E. coli −++ P. aeruginosa −++ S. pyogenes −++ C. albicans −++ |
| 20 | 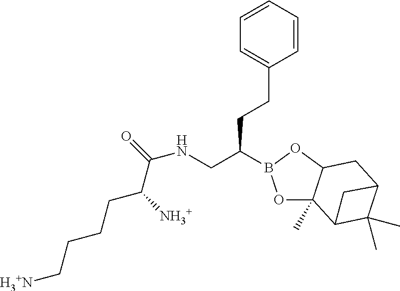 | tlo_253_489 | M. tuberculosis −−+ S. aureus ±−+ E. coli +++ P. aeruginosa ±±+ S. pyogenes ±±+ C. albicans ±±+ |
| 21 | 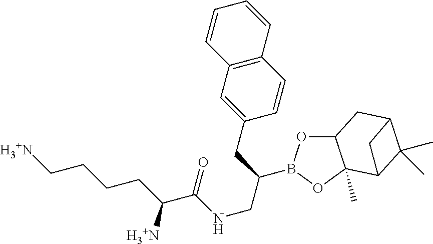 | tlo_263_499 | M. tuberculosis −−− S. aureus +±+ E. coli +++ P. aeruginosa ±++ S. pyogenes ±++ C. albicans ±++ |
| 22 | 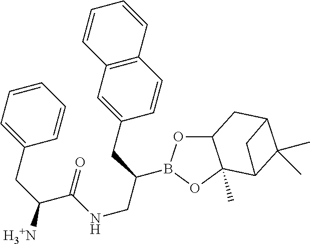 | tlo_217_453 | *M. tuberculosis −++ S. aureus +±+ E. coli +++ P. aeruginosa +±+ S. pyogenes +−+ C. albicans ±−+ |
| 23 | 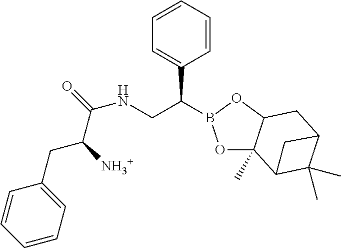 [SMILES: CC1(C)C2CC3OB([C@@H](CNC(=O)[C@@H]([NH3+])Cc4ccccc4)c4ccccc4)O[C@]3(C)C1C2] | tlg_257_712HCl | M. tuberculosis −++ S. aureus −++ S. pyogenes −++ C. albicans −++ |
| 24 | 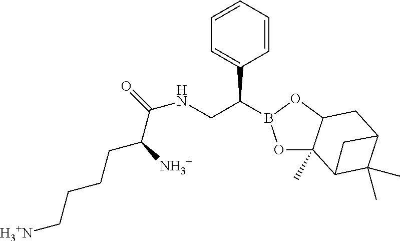 | tlg_225_708 | M. tuberculosis −++ |
| 25 | 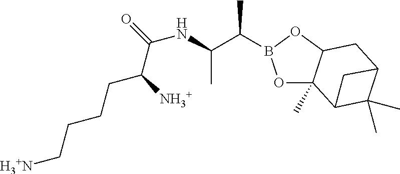 | tlg_270_744 | Was not tested |
| 26 | 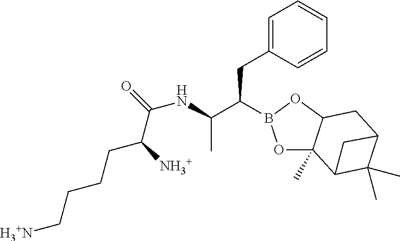 | tlg_230_638 | M. tuberculosis −−− S. aureus −++ E. coli −++ S. pyogenes −++ C. albicans −++ P. aeruginosa −++ |
| 27 | 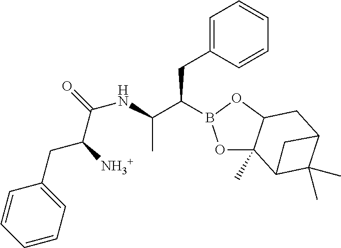 [SMILES: C[C@@H](NC(=O)[C@@H]([NH3+])Cc1ccccc1)[C@@H](Cc1ccccc1)B1OC2CC3CC(C3(C)C)[C@@]2(C)O1] | tlg_226_628 | M. tuberculosis ±−+ S. pyougenes ±++ C. albicans ±++ |
| 28 | 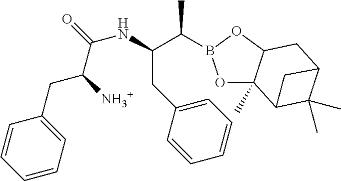 [SMILES: C[C@@H](B1OC2CC3CC(C3(C)C)[C@@]2(C)O1)[C@@H](Cc1ccccc1)NC(=O)[C@@H]([NH3+])Cc1ccccc1] | tlg_211_578 | M. tuberculosis −−+ S. aureus ±++ S. pyogenes ±++ C. albicans ±++ |
| 29 | 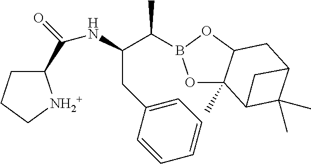 [SMILES: C[C@@H](B1OC2CC3CC(C3(C)C)[C@@]2(C)O1)[C@@H](Cc1ccccc1)NC(=O)[C@@H]1CCC[NH2+]1] | tlg_261_720 | M. tuberculosis −++ S. aureus −++ S. pyogenes −++ C. albicans ±++ P. aeruginosa ±++ |
| 30 | 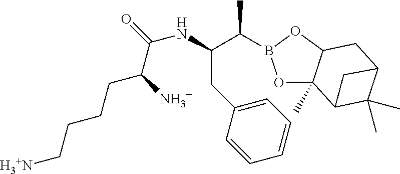 | tlg_212_580 | M. tuberculosis −−+ S. aureus −++ E. coli −++ S. pyogenes −++ C. albicans −++ P. aeruginosa −++ |
| 31 | 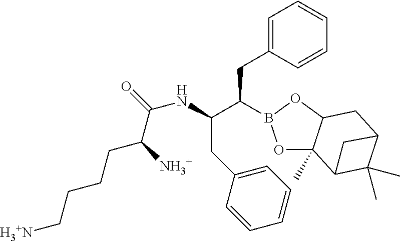 | tlg_247_692 | M. tuberculosis −−+ S. aureus −++ E. coli −++ S. pyogenes −++ C. albicans −++ P. aeruginosa −++ |
| 32 | 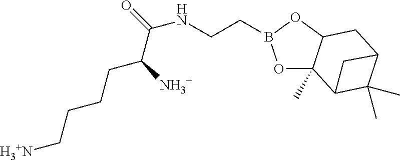 | tlg_237_664 | M. tuberculosis −++ E. coli ±++ C. albicans −++ |
| 33 | 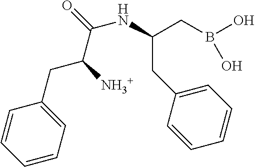 [SMILES: [NH3+][C@@H](Cc1ccccc1)C(=O)N[C@@H](CB(O)O)Cc1ccccc1] | tlg_110_621 | M. tuberculosis −−± |
| 34 | 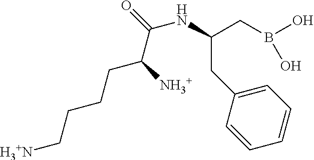 | tlg_132 | M. tuberculosis −−+ S. aureus −++ E. coli −++ E. faecalis −++ P. aeruginosa −++ |
| 35 | 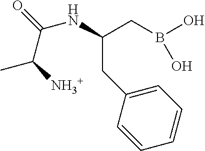 [SMILES: C[C@H]([NH3+])C(=O)N[C@@H](CB(O)O)Cc1ccccc1] | tlg_123_326 | M. tuberculosis −++ |
| 36 | 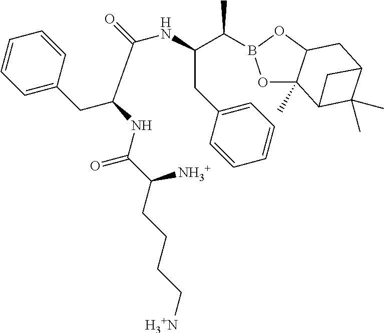 | tlg_213_582 | M. tuberculosis −−+ S. aureus −++ E. coli −++ P. aeruginosa −++ S. pyogenes −++ C. albicans ±++ |
| 37 | 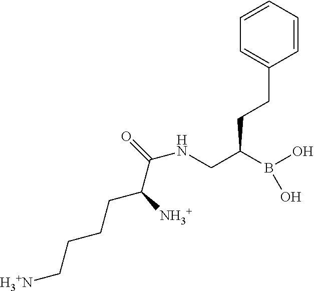 | tlo_247_483 | M. tuberculosis −++ C. albicans −++ |
| 38 | 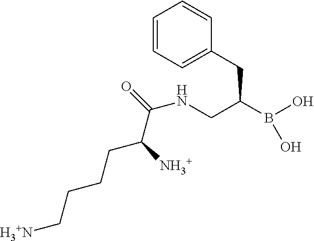 | tlo_251_487 | M. tuberculosis −−− S. aureus ±++ E. coli ±++ P. aeruginosa +++ S. pyogenes −++ C. albicans ±++ |
| 39 | 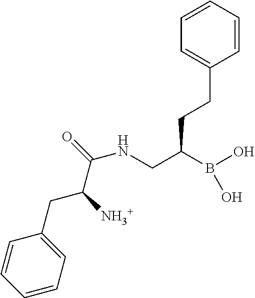 [SMILES: [NH3+][C@@H](Cc1ccccc1)C(=O)NC[C@@H](CCc1ccccc1)B(O)O] | tlo_245_481 | M. tuberculosis −++ E. coli −++ |
| 40 | 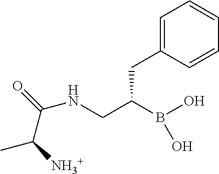 [SMILES: C[C@H]([NH3+])C(=O)NC[C@H](Cc1ccccc1)B(O)O] | tlo_230 | M. tuberculosis −±± |
| 41 | 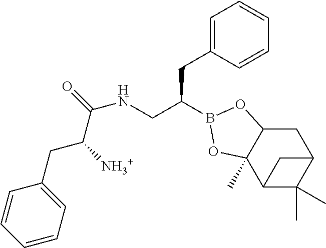 [SMILES: CC1(C)C2CC3OB([C@@H](CNC(=O)[C@H]([NH3+])Cc4ccccc4)Cc4ccccc4)O[C@]3(C)C1C2] | tlg_305_826 | M. tuberculosis ±±+ S. aureus ±++ E. coli +++ P. aeruginosa +++ S. pyogenes ±++ C. albicans ±±+ |
| 42 | 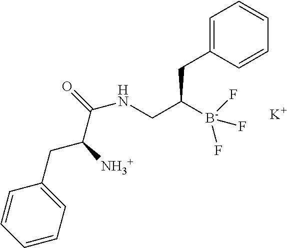 [SMILES: [NH3+][C@@H](Cc1ccccc1)C(=O)NC[C@@H](Cc1ccccc1)[B-](F)(F)F ; [K+]] | tlg_311_840 | M. tuberculosis −−+ S. aureus +++ E. coli +++ P. aeruginosa +++ S. pyogenes ±++ C. albicans ±±+ |
| 43 | 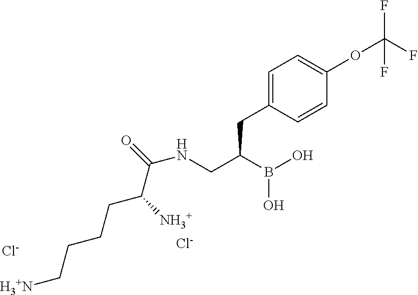 | tlo_296_536 | M. tuberculosis −++ S. aureus −++ E. coli −++ P. aeruginosa −++ S. pyogenes −++ C. albicans ±++ |
| 44 | 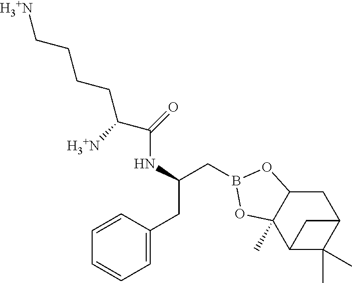 | tlo_282_522 | M. tuberculosis −++ S. aureus −++ E. coli −++ P. aeruginosa −++ S. pyogenes −++ C. albicans ±++ |
| 45 | 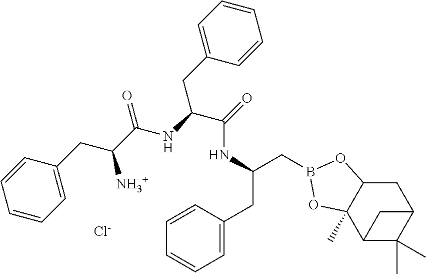 [SMILES: CC1(C)C2CC3OB(C[C@@H](Cc4ccccc4)NC(=O)[C@H](Cc4ccccc4)NC(=O)[C@@H]([NH3+])Cc4ccccc4)O[C@]3(C)C1C2 ; [Cl-]] | Tlg_323_872 | M. tuberculosis +−+ S. aureus +±+ E. coli +++ S. pyogenes +++ C. albicans −++ P. aeruginosa +++ |
| 46 | 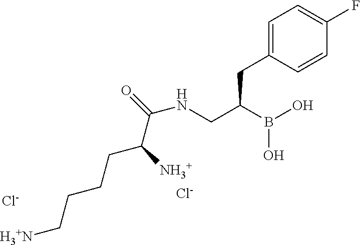 | Tlo_289_529 | M. tuberculosis −−− S. aureus +++ E. coli +++ S. pyogenes +++ C. albicans ±++ P. aeruginosa +++ |
| 47 | 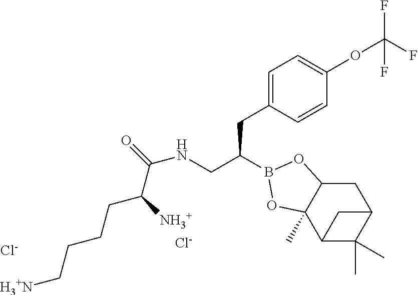 | Tlo_293_533 | M. tuberculosis −−+ S. aureus −++ E. coli −++ S. pyogenes −++ C. albicans −++ P. aeruginosa −++ |
| 48 | 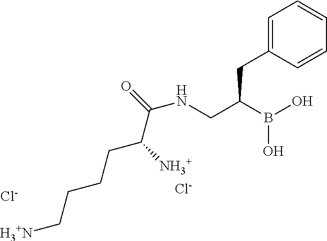 | Tlo_261_497 | M. tuberculosis −−± S. aureus +++ E. coli +++ S. pyogenes +++ C. albicans +++ P. aeruginosa +++ |
| 49 | 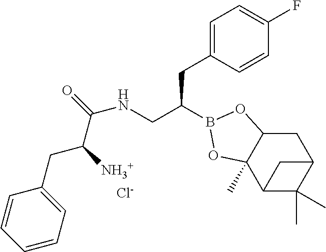 [SMILES: CC1(C)C2CC3OB([C@@H](CNC(=O)[C@@H]([NH3+])Cc4ccccc4)Cc4ccc(F)cc4)O[C@]3(C)C1C2 ; [Cl-]] | Tlo_288_528 | M. tuberculosis −−± S. aureus +++ E. coli +++ S. pyogenes +++ C. albicans +++ P. aeruginosa +++ |
| 50 | 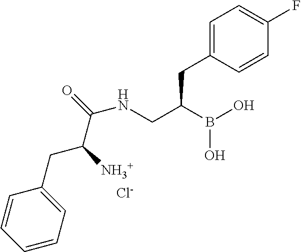 [SMILES: [NH3+][C@@H](Cc1ccccc1)C(=O)NC[C@@H](Cc1ccc(F)cc1)B(O)O ; [Cl-]] | Tlo_290_530 | M. tuberculosis −−± S. aureus −++ E. coli −++ S. pyogenes −++ C. albicans +++ P. aeruginosa ±++ |
| 51 | 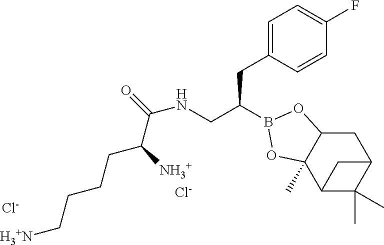 | Tlo_287_527 | M. tuberculosis −−+ S. aureus −++ E. coli −++ S. pyogenes −++ C. albicans −++ P. aeruginosa −++ |
| 52 | 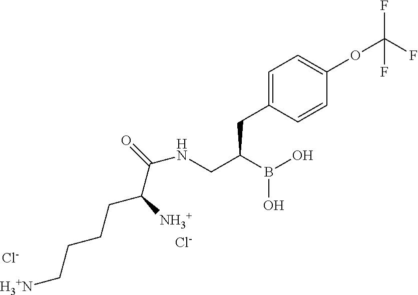 | Tlo_295_535 | M. tuberculosis −±± S. aureus +++ E. coli +++ S. pyogenes ±++ C. albicans −++ P. aeruginosa +++ |
| 53 | 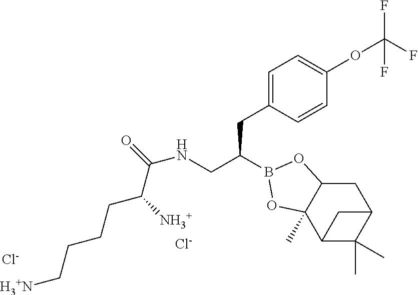 | Tlo_294_534 | M. tuberculosis −−± S. aureus +++ E. coli +++ S. pyogenes −++ C. albicans −++ P. aeruginosa −++ |
| 54 | 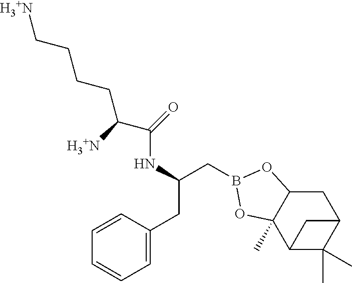 | Tlo_281_521 | M. tuberculosis −++ S. aureus −++ E. coli −++ S. pyogenes −++ C. albicans −++ P. aeruginosa −++ |
| 55 | 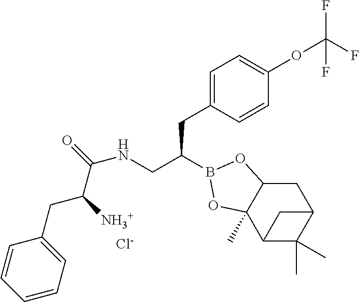 [SMILES: CC1(C)C2CC3OB([C@@H](CNC(=O)[C@@H]([NH3+])Cc4ccccc4)Cc4ccc(OC(F)(F)F)cc4)O[C@]3(C)C1C2 ; [Cl-]] | Tlo_275_515 | M. tuberculosis −−− S. aureus +±+ E. coli +++ S. pyogenes +±+ C. albicans ±++ P. aeruginosa +++ |
| 56 | 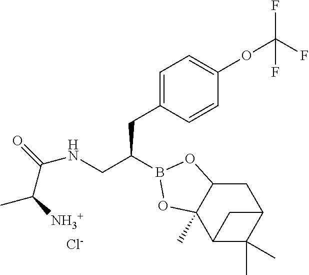 [SMILES: C[C@H]([NH3+])C(=O)NC[C@@H](Cc1ccc(OC(F)(F)F)cc1)B1OC2CC3CC(C3(C)C)[C@@]2(C)O1 ; [Cl-]] | Tlo_276_516 | M. tuberculosis −−+ S. aureus +±+ E. coli +++ S. pyogenes +−+ C. albicans ±±+ P. aeruginosa +++ |
| 57 | 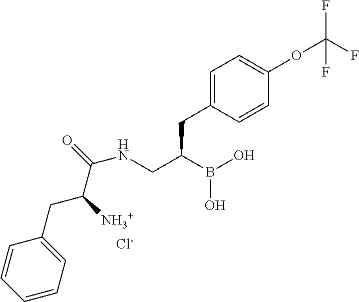 [SMILES: [NH3+][C@@H](Cc1ccccc1)C(=O)NC[C@@H](Cc1ccc(OC(F)(F)F)cc1)B(O)O ; [Cl-]] | Tlo_277_517 | M. tuberculosis −−+ S. aureus +++ E. coli ±++ S. pyogenes −++ C. albicans −++ P. aeruginosa −++ |

* = result on solid media (compound 22)

### Antifungal activity of α-naphthyl-β-amino-(−)-pinanedioleboronate-N-

Compound 22 (the chloride salt) of table 1 was dissolved and the solution applied to a filter paper disc of diameter 5 mm. The filter paper discs were placed on plates containing the following strains of Candida albicans:

ATCC90028 (“wild type”, i.e. not resistant to nystatin or fluconazole)

ATCC38247 (resistant to fluconazole)

MYA576 (resistant to nystatin).

The compound was applied at concentrations of 0.5, 1, 5, 10, 25 and 50 μg/ml. Nystatin and fluconazole at the same concentrations were applied in the same manner. The agar plates were kept at 37° C. for 24 hours and then the diameter was measured, from the centre of the filter paper, of the area which did not show any Candida growth. All strains were tested at least three times.

The results of these measurements, in millimeters, are presented in Table 2 below. Clearly, the higher the number, the greater the antifungal activity.

TABLE 2

| | Nystatin | Fluconazole | TLO | Fluconazole | TLO | Nystatin | TLO |
|---|---|---|---|---|---|---|---|
| | ATCC90028 | | | ATCC38247 | | MYA576 | |
| 0.5 | 6.25 | 7.33 | 5 | 5 | 5 | 5 | 5.33 |
| 1 | 7.25 | 13.33 | 6 | 5 | 5.21 | 5 | 6.67 |
| 5 | 9.25 | 21.33 | 6.875 | 5 | 7.43 | 5 | 10.67 |
| 10 | 14.75 | 25.66 | 11.75 | 5 | 12.86 | 6.17 | 12.67 |
| 25 | 19.25 | 30 | 15.25 | 5 | 17.29 | 7.33 | 14.33 |
| 50 | 20.25 | 31.33 | 17 | 5 | 19.14 | 9 | 15.67 |

TLO is compound 22 of the invention and showed activity at concentrations as low as 1 μg/ml.

1. A compound of Formula (I), 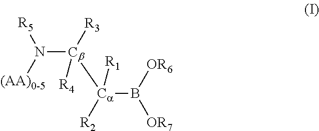
wherein
R₁ and R₃ are hydrogen;
R₂ and R₄, which may be the same or different, are hydrogen, a C₁₋₆ alkyl group optionally substituted by an aryl group which may itself be substituted, the substituent group including an alkyl group or an —OR group in which R is a C₁₋₃ alkyl group, with one or more hydrogen atoms optionally replaced with a halogen atom; or an aryl group which may be substituted, the substituent group including an alkyl group or an —OR group in which R is a C₁₋₃ alkyl group, with one or more hydrogen atoms optionally replaced with a halogen atom; with the proviso that R₂ and R₄ are not both hydrogen;
R₄ is hydrogen or the atom of R₄ which is attached to C_{β} is either a saturated carbon atom or an atom which is part of a substituted aromatic ring;
(AA)₀₋₅ is an amino acid, amino acid derivative, peptide of up to 5 amino acids or a peptidomimetic thereof which optionally incorporates an N-terminal capping group, when the group is (AA)₀ an N-terminal capping group is present, covalently attached to the nitrogen atom shown in Formula (I) and the capping group comprises at least 5 non-hydrogen atoms;
R₅ is hydrogen or a C₁₋₃ alkyl group, when AA=0, R₅ may form a cyclic group with the N-terminal capping group;
R₆ and R₇ independently of one another denote hydrogen or a C₁₋₆ alkyl group; or together with the boron atom and the oxygen atoms, form a mono-, bi- or tricyclic, saturated or partly unsaturated, mono-, di-, tri- or tetra-C₁₋₆ alkylated or phenylated ring system having 5-18 ring members;
and salt forms and stereoisomers thereof.

2. A compound of Formula (VII), 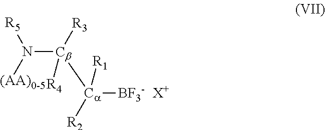
wherein
R₁ and R₃ are hydrogen;
R₂ and R₄, which may be the same or different, are hydrogen, a C₁₋₆ alkyl group optionally substituted by an aryl group which may itself be substituted, the substituent group including an alkyl group or an —OR group in which R is a C₁₋₃ alkyl group, with one or more hydrogen atoms optionally replaced with a halogen atom; or an aryl group which may be substituted, the substituent group including an alkyl group or an —OR group in which R is a C₁-₃ alkyl group, with one or more hydrogen atoms optionally replaced with a halogen atom; with the proviso that R₂ and R₄ are not both hydrogen;
R₄ is hydrogen or the atom of R₄ which is attached to C_{β} is either a saturated carbon atom or an atom which is part of a substituted aromatic ring;
(AA)₀₋₅ is an amino acid, amino acid derivative, peptide of up to 5 amino acids or a peptidomimetic thereof which optionally incorporates an N-terminal capping group, when the group is (AA)₀ an N-terminal capping group is present, covalently attached to the nitrogen atom shown in Formula (VII) and the capping group comprises at least 5 non-hydrogen atoms;
R₅ is hydrogen or a C₁₋₃ alkyl group, when AA=0, R₅ may form a cyclic group with the N-terminal capping group;
X⁺ is a counterion;
and salt forms and stereoisomers thereof.

3. The compound of claim 1 or claim 2 wherein one of R₂ and R₄ is methyl and the other group is either a methyl group or a group larger than methyl.

4. The compound of claim 1 or claim 2 wherein R₂ or R₄ is a C₁₋₆ alkyl group substituted by an aryl group which has optionally had one or more hydrogen atoms replaced with a halogen atom.

5. The compound of claim 1 or claim 2 wherein R₂ or R₄ is a C₁₋₆ alkyl group substituted by an aryl group which is substituted by a group —OCF₃.

6. The compound of claim 1 or claim 2, wherein each of R₂ and R₄ is selected from the group consisting of hydrogen, a C₁₋₆ alkyl group, phenethyl, benzyl, 4-(F)-benzyl, 4-(CF₃O)-benzyl, 2-naphthylmethyl or phenyl, but R₂ and R₄ are not both hydrogen.

7. The compound of claim 1 or claim 2, wherein (AA)₀₋₅ consists of one or two amino acids or amino acid derivatives or equivalent subunits.

8. The compound of claim 1 or claim 2, wherein (AA)₀₋₅ is a peptide or peptidomimetic of 1 to 5 amino acids or equivalent subunits and is attached to the rest of the molecule by an amide bond.

9. The compound of claim 1, further defined as a compound of Formula (VI), 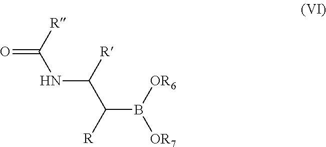
wherein
R and R′, which may be the same or different, are hydrogen, a C₁₋₆ alkyl group optionally substituted by an aryl group which may itself be substituted, the substituent group including an alkyl group or an —OR group in which R is a C₁₋₃ alkyl group, with one or more hydrogen atoms optionally replaced with a halogen atom; or an aryl group which may be substituted, the substituent group including an alkyl group or an —OR group in which R is a C₁₋₃ alkyl group, with one or more hydrogen atoms optionally replaced with a halogen atom; with the proviso that R₂ and R₄ are not both hydrogen;
R″ is an amino acid, amino acid derivative, peptide of up to 5 amino acids or a peptidomimetic thereof; and
R₆ and R₇ are as defined in claim 1;
and salt forms and stereoisomers thereof.

10. The compound of claim 9 further defined as a compound of Formula (IV) 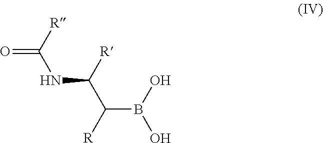
or Formula (V) 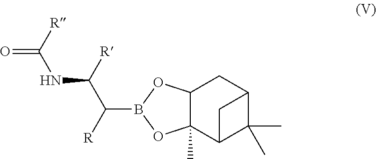
wherein R, R′ and R″ are as defined in claim 9;
and salt forms and stereoisomers thereof.

11. The compound of claim 10 further defined as a compound of Formula (II) 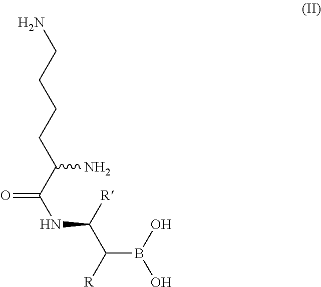
or Formula (III) 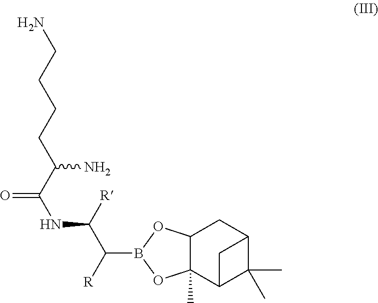
wherein R and R′ are as defined in claim 9
and salt forms and stereoisomers thereof.

12. The compound of claim 1 or claim 2, wherein said halogen atom is a fluorine atom.

13. The compound of claim 1 or claim 2, wherein said amino acid or amino acid derivative is selected from the list consisting of lysine, arginine, alanine, proline, asparagine, aspartic acid, phenylalanine, tryptophan, homolysine, ornithine, diaminobutyric acid, diaminopimelic acid, diaminopropionic acid, trimethyllysine and homoarginine.

14. The compound of claim 1 or claim 2 wherein the compound is selected from those disclosed in Table 1 herein.

15-17. (canceled)

18. A method of treating a bacterial or fungal infection comprising administering a pharmaceutically effective amount of a compound as claimed in claim 1 or claim 2 to a patient in need thereof.

19. The method of claim 18 wherein the bacterial infection is a Mycobacterium tuberculosis infection or a Candida albicans infection.

20. A pharmaceutical formulation comprising a compound as claimed in claim 1 or claim 2 and a suitable diluent, carrier or excipient.
